(19) United States
(12) Patent Application Publication
(10) Pub. No.: US 2005/0200789 A1
(43) Pub. Date: Sep. 15, 2005

(54) Liquid crystal display device

(75) Inventor: Yohei Nakanishi, Kawasaki (JP)

Correspondence Address: Patrick G. Burns, Esq.;GREEN, BURNS & CRAIN, LTD., Suite 2500, 300 South Wacker Dr., Chicago, IL, 60606, US

(73) Assignees: FUJITSU DISPLAY TECHNOLOGIES CORPORATION; AU OPTRONICS CORPORATION

(21) Appl. No.: 10/935,017

(22) Filed: Sep. 7, 2004

(30) Foreign Application Priority Data
Mar. 12, 2004 (JP) 2004-071178

(51) Int. Cl. G02F 1/1343

(52) U.S. Cl. 349/139

(57) ABSTRACT

In the middle of each picture element electrode on a TFT substrate, a slit parallel to gate bus lines is formed. On a counter substrate, protrusions are formed. Each protrusion includes a protrusion placed along the left edge of the upper half of a picture element electrode, a protrusion horizontally extending from the middle of the preceding protrusion, a protrusion placed along the right edge of the lower half of the picture element electrode, and a protrusion horizontally extending from the middle of the preceding protrusion. Liquid crystal molecules are aligned with directions of approximately 45° relative to the protrusions and the edges of the picture element electrodes.

### CROSS-REFERENCE TO RELATED APLICATIONS

This application is based on and claims priority of Japanese Patent Application No. 2004-071178 filed on Mar. 12, 2004, the entire contents of which are incorporated herein by reference.

### BACKGROUND OF THE INVENTION

1. Field of the Invention

The present invention relates to a multi-domain vertical alignment (MVA) mode liquid crystal display device having, within each picture element, multiple domains where the alignment directions of liquid crystal molecules are different from each other.

2. Description of the Prior Art

Liquid crystal display devices have the advantages in that they are thin and light in weight compared to cathode-ray tube (CRT) displays and that they can be driven at low voltages to have low power consumption. Accordingly, liquid crystal display devices are used in various kinds of electronic devices including televisions, notebook personal computers (PCs), desktop PCs, personal digital assistants (PDAs), and mobile phones. In particular, active matrix liquid crystal display devices in which a thin film transistor (TFT) as a switching element is provided for each picture element (sub-pixel) show excellent display characteristics, which are comparable to those of CRT displays, because of high driving capabilities thereof, and therefore have been widely used even in fields where CRT displays have been used heretofore, such as desktop PCs and televisions.

In general, a liquid crystal display device has a structure in which liquid crystals are contained in the space between two transparent substrates. On one of the two transparent substrates, a picture element electrode, a TFT, and the like are formed for each picture element; on the other substrate, color filters facing the picture element electrodes and a common electrode, which is common to the picture elements, are formed. Hereinafter, the substrate on which the picture element electrodes and the TFTs are formed is referred to as a TFT substrate, and the substrate placed to face the TFT substrate is referred to as a counter substrate. Note that, in a color liquid crystal display device, three picture elements of red (R), green (G), and blue (B) which are adjacently placed constitute one pixel.

TN-mode liquid crystal display devices have been heretofore widely used in which horizontal alignment-type liquid crystals (liquid crystals with positive dielectric anisotropy) are contained in the space between a pair of substrates and in which liquid crystal molecules are twisted and aligned. However, TN-mode liquid crystal display devices have the disadvantage that viewing angle characteristics are poor and that contrast and color greatly change when a screen is viewed from an oblique direction. Accordingly, multi-domain vertical alignment (MVA) mode liquid crystal display devices and in-plane switching (IPS) mode liquid crystal display devices, which have favorable viewing angle characteristics, have been developed and put into practical use.

In an IPS-mode liquid crystal display device, liquid crystal molecules are switched by a comb-shaped electrode in a plane parallel to substrate planes. However, since the aperture ratio is significantly reduced by the comb-shaped electrode, there is a drawback in that a strong backlight is required.

On the other hand, in an MVA-mode liquid crystal display device, the alignment directions of liquid crystal molecules are regulated by such structures as protrusions and slits in electrodes. Further, in Patent Application Publication No. 2002-229029, an MVA-mode liquid crystal display device has been disclosed in which picture element electrodes are formed on inclined surfaces to achieve multi-domain. However, also in the case of an MVA-mode liquid crystal display device, since the aperture ratio is reduced by protrusions and slits though less than that of an IPS-mode liquid crystal display device, the light transmittance is low compared to that of a TN-mode liquid crystal display device. Accordingly, it is often said that IPS and MVA-mode liquid crystal display devices are not suitable for notebook PCs, which require low power consumption.

In conventional MVA-mode liquid crystal display devices, domain regulation structures (protrusions, slits, and the like) are complexly arranged so that liquid crystal molecules are tilted in four directions for achieving a wider viewing angle when a voltage is applied. This causes the reduction in the aperture ratio. Accordingly, an MVA-mode liquid crystal display device has been proposed in which the arrangement of domain regulation structures is simplified.

FIG. 1 is a plan view showing the above-described MVA-mode liquid crystal display device. In this FIG. 1, two picture elements provided on a TFT substrate are shown. Further, in FIG. 1, liquid crystal molecules 30a are schematically shown in such a manner that the alignment directions of the liquid crystal molecules can be seen.

On the TFT substrate, a plurality of gate bus lines 11 horizontally extending and a plurality of data bus lines 15 vertically extending are formed. Each of the rectangular areas defined by the gate and data bus lines 11 and 15 is a picture element area. The gate bus lines 11 are electrically isolated from the data bus lines 15 by a first insulating film (not shown) formed therebetween.

For each picture element area, a TFT 14 and a picture element electrode 16 are formed. In the TFT 14, part of a gate bus line 11 is used as a gate electrode. Further, the drain electrode 14d of the TFT 14 is connected to a data bus line 15, and the source electrode 14s thereof is formed at a position where the source electrode 14s faces the drain electrode 14d across the gate bus line 11.

The TFT 14 and the data bus line 15 are covered with a second insulating film (not shown), and the picture element electrode 16 is formed on the second insulating film. This picture element electrode 16 is electrically connected to the source electrode 14s of the TFT 14 through a contact hole (not shown) formed in the second insulating film.

The picture element electrode 16 is made of transparent conductive material such as indium-tin oxide (ITO). Further, in the picture element electrode 16, four areas in which the directions of slits 16a are different from each other are provided in order to achieve multi-domain in which the alignment directions of liquid crystal molecules 30a are four directions. That is, slits 16a are provided to make an angle of 45° relative to the X-axis direction (horizontal direction) in a first area (upper right area), slits 16a are provided to make an angle of 135° relative to the X-axis direction in a second area (upper left area), slits 16a are provided to make an angle of 225° relative to the X-axis direction in a third area (lower left area), and slits 16a are provided to make an angle of 315° relative to the X-axis direction in a fourth area (lower right area).

On a counter substrate, which is placed to face the TFT substrate, a black matrix, color filters, and a common electrode are formed. In this liquid crystal display device, domain regulation structures, such as protrusions and slits, are not provided on the counter substrate.

In such a liquid crystal display device, when a voltage is applied to a picture element electrode 16 and the common electrode, the liquid crystal molecules 30a are tilted in directions parallel to the slits 16a. At this time, due to the influence of electric fields at the tips of the slits 16a, the directions in which the liquid crystal molecules 30a are tilted are opposite between the first and third areas, and the directions in which the liquid crystal molecules 30a are tilted are opposite between the second and fourth areas. Accordingly, the tilt directions of the liquid crystal molecules 30a are different from each other among the four areas.

In the MVA-mode liquid crystal display device shown in FIG. 1, domain regulation structures (protrusions, slits, or the like) are not provided on the counter substrate, and the shapes of the domain regulation structures (slits) on the TFT substrate are simple. Accordingly, the light transmittance is high, and a strong backlight is not required. Consequently, the MVA-mode liquid crystal display device shown in FIG. 1 can be adopted as a display of a notebook PC, which requires low power consumption.

In such an MVA-mode liquid crystal display device as shown in FIG. 1, though the liquid crystal molecules 30a are tilted parallel to the slits 16a of the picture element electrode 16, the directions in which the liquid crystal molecules 30a are tilted at this time are determined by electric fields at the tips of the slits 16a of the picture element electrode 16. Moreover, the directions in which the liquid crystal molecules are tilted propagate from the tips of the slits 16a toward the central portion of the picture element, and the directions in which all liquid crystal molecules in the picture element are tilted are thus determined. Accordingly, a liquid crystal display device having the picture element electrodes shown in FIG. 1 has the disadvantage that it takes a relatively long time for all liquid crystal molecules in one picture element to be tilted in predetermined directions after a voltage has been applied.

Accordingly, a technology has been developed wherein liquid crystals to which a polymerization component (reactive monomers) has been added are filled and sealed in the space between a pair of substrates and wherein the directions in which liquid crystal molecules are tilted are thereafter stored by use of polymers formed by polymerizing the monomers in the state where a voltage is applied (Patent Application Publication No. 2003-149647). In this technology, since the directions in which the liquid crystal molecules are tilted are determined by the polymers formed in a liquid crystal layer, the response speed of the liquid crystal molecules is improved.

However, the inventors of the present application believe that the above-described prior art has the following problem.

In an MVA-mode liquid crystal display device having the picture element electrodes shown in FIG. 1, the slits 16a of the picture element electrodes 16 are formed by photolithography. At this time, if an exposure mask having the same size as a liquid crystal panel is used, cost becomes significantly high. Accordingly, a small exposure mask is used, and exposure is performed a plurality of times while the exposed position is being shifted each time. However, the exposure value, the thickness of a photomask, and the like slightly change for each exposure, and variation in slit widths occurs.

The variation in slit widths thus occurred causes variation in optical characteristics between picture elements. As a result, when a pattern of intermediate tones is displayed on the entire screen of the liquid crystal display device, slight color shading occurs. This color shading sometimes become visible as a tiled pattern.

### SUMMARY OF THE INVENTION

In the light of the above, an object of the present invention is to provide a liquid crystal display device in which a tiled pattern does not easily occur and which has more excellent display performance than heretofore.

The above-described problem is solved by a liquid crystal display device including: a first substrate on which a picture element electrode is formed for each picture element area; a second substrate on which a common electrode placed to face the picture element electrode is formed; and a liquid crystal layer comprising vertical alignment-type liquid crystals filled and sealed in a space between the first and second substrates. Here, each picture element area is divided into a plurality of rectangular areas, two adjacent sides of each rectangular area are defined by embankment-like protrusions made of dielectric material, other two sides are defined by edges of the picture element electrode, and liquid crystal molecules are aligned with directions intersecting each side of the rectangular area when a voltage is applied between the picture element electrode and the common electrode.

In the present invention, each picture element area is divided into a plurality of rectangular areas. Further, two adjacent sides of each rectangular area are defined by embankment-like protrusions made of dielectric material, and other two sides are defined by edges (including edges of a slit provided in the picture element electrode) of the picture element electrode. Moreover, vertical alignment-type liquid crystals (liquid crystals with negative dielectric anisotropy) are used as the liquid crystals to be filled and sealed in the space between the first and second substrates.

When a voltage is applied between the picture element electrode and the common electrode, forces which tend to tilt liquid crystal molecules in directions perpendicular to the protrusions act on the liquid crystal molecules in the vicinities of the protrusions, and forces which tend to tilt liquid crystal molecules in directions perpendicular to the edges of the picture element electrode act on the liquid crystal molecules in the vicinities of the edges. Further, in each rectangular area, forces which tend to tilt liquid crystal molecules in two orthogonal directions act on the liquid crystal molecules in the four corners of the rectangular area, and the liquid crystal molecules are, consequently, tilted in a direction of approximately 45° relative to a protrusion or an edge of the picture element electrode. This tilt direction of the liquid crystal molecules is propagated to other liquid crystal molecules in the rectangular area, and all liquid crystal molecules in the rectangular area are aligned with a direction (direction of approximately 45°) intersecting the protrusion or the edge of the electrode. By changing the alignment direction of liquid crystal molecules depending on the plurality of rectangular areas, multi-domain can be achieved, and a liquid crystal display device having favorable viewing angle characteristics can be obtained.

In the liquid crystal display device of the present invention, since the tilt directions of liquid crystal molecules are not determined by the slits, it is possible to prevent the occurrence of a tiled pattern due to a photolithography process for forming slits. Further, for example, by forming the protrusions along outer edges of the picture element electrode, the reduction in light transmittance due to the protrusions can be decreased, and a liquid crystal display device usable in a display of a notebook PC which requires low power consumption can be obtained.

Moreover, a liquid crystal display device having a high response speed can be obtained by forming, in the liquid crystal layer, polymers which stores the tilt directions of liquid crystal molecules. Furthermore, disorderly alignment of liquid crystal molecules in the middle portions of edges can be prevented by forming oblique slits extending along the alignment directions of liquid crystal molecules when a voltage is applied, in only edge-side portions which define the rectangular areas, and thus light transmittance is further improved.

The aforementioned problem is solved by a liquid crystal display device including: a first substrate on which a picture element electrode is formed for each picture element area; a second substrate on which a common electrode placed to face the picture element electrode is formed; and a liquid crystal layer comprising vertical alignment-type liquid crystals filled and sealed in a space between the first and second substrates. Here, the picture element electrode has stripe-shaped slits for defining alignment directions of liquid crystal molecules, and L+D−S≧4 μm is satisfied, where a width of each slit is denoted by S, a distance between the slits is denoted by L, and a cell gap is denoted by D.

The inventors of the present application and others fabricated a large number of liquid crystal display devices having different slit widths S, distances L between the slits, and cell gaps D, and investigated whether tiled patterns would occur or not. As a result, it turned out that a tiled pattern did not occur in the case where the value of L+D−S was 4 μm or less.

However, light transmittance is reduced when the slit width S exceeds 4 μm, and liquid crystal molecules cannot be tilted in predetermined directions when the slit width S exceeds 7 μm. Accordingly, the slit width S is preferably set to 7 μm or less, more preferably 4 μm or less. Moreover, light transmittance is sharply reduced when the distance L between the slits exceeds 6 μm, and disclination occurs on the electrode when the distance L between the slits exceeds 7 μm. Accordingly, the distance L between the slits is preferably set to 7 μm or less, more preferably 6 μm or less. Furthermore, retardation becomes small and reduces brightness when the cell gap D is less than 2 μm, and retardation becomes too large and exacerbates viewing angle characteristics when the cell gap D exceeds 6 μm. Accordingly, the cell gap D should preferably be set to 2 to 6 μm.

### BRIEF DESCRIPTION OF THE DRAWINGS

FIG. 1 is a plan view showing an example of a known MVA-mode liquid crystal display device.

FIG. 2 is a plan view showing a liquid crystal display device of a first embodiment of the present invention.

FIG. 3 is a schematic cross section view taken along the I-I line of FIG. 2.

FIG. 4 is a view showing the alignment state of liquid crystal molecules immediately after a voltage has been applied between a picture element electrode and a common electrode in the first embodiment.

FIG. 5 is a view showing the alignment directions of liquid crystal molecules in first to fourth areas in the first embodiment.

FIG. 6 is a graph showing the relationship between the height h of a protrusion and transmittance by putting the height h on the horizontal axis and putting the transmittance on the vertical axis.

FIG. 7 is a graph showing the relationship between the distance x from an edge of the picture element electrode to the top of the protrusion and the transmittance by putting the distance x on the horizontal axis and putting the transmittance on the vertical axis.

FIG. 8 is a view showing liquid crystal molecules tilted in directions shifted from 45° in the middle portions of protrusions and the middle portions of edges of the picture element electrode.

FIG. 9 is a schematic diagram showing regions with low transmittance which occur when liquid crystal molecules are aligned as shown in FIG. 8.

FIG. 10 is a plan view showing a liquid crystal display device of a second embodiment of the present invention.

FIG. 11 is a plan view showing a liquid crystal display device of a third embodiment of the present invention.

FIGS. 12A and 12B are schematic diagrams showing the change of the curvatures of electric flux lines depending on slit widths.

FIG. 13 is a plan view showing a liquid crystal display device of a fourth embodiment of the present invention.

FIG. 14 is a plan view showing a liquid crystal display device of a fifth embodiment of the present invention.

FIG. 15 is a schematic cross-sectional view taken along the II-II line of FIG. 14.

FIG. 16 is a plan view of a liquid crystal display device according to a sixth embodiment of the present invention.

FIG. 17 is a schematic cross-sectional view taken along the III-III line of FIG. 16.

FIG. 18 is a plan view showing a liquid crystal display device of a seventh embodiment of the present invention.

FIG. 19 is a schematic cross-sectional view taken along the IV-IV line of FIG. 18.

FIG. 20 is a plan view of a liquid crystal display device for explaining an eighth embodiment of the present invention.

FIG. 21 is a graph showing the relationship between a fine electrode width L (design value) and the value of a transmittance ratio T′(V)/T(V) by putting the fine electrode width L on the horizontal axis and putting the value of the transmittance ratio T′(V)/T(V) on the vertical axis.

FIG. 22 is a graph showing the relationship between the slit width S (design value) and the transmittance ratio T′(V)/T(V) by putting the slit width S on the horizontal axis and putting the transmittance ratio T′(V)/T(V) on the vertical axis.

FIG. 23 is a graph showing the relationship between a cell gap D and the transmittance ratio T′(V)/T(V) by putting the cell gap D on the horizontal axis and putting the transmittance ratio T′(V)/T(V) on the vertical axis.

FIG. 24 is a graph showing the relationship between the fine electrode width L and the transmittance by putting the fine electrode width L on the horizontal axis and putting the transmittance on the vertical axis.

FIG. 25 is a graph showing the relationship between the slit width S and brightness by putting the slit width S on the horizontal axis and putting the brightness on the vertical axis.

FIG. 26 is a graph showing the result of manufacturing a large number of liquid crystal display devices and investigating the relationship between the value of L+D−S and the transmittance ratio T′(V)/T(V).

### DESCRIPTION OF THE PREFERRED EMBODIMENTS

Hereinafter, embodiments of the present invention will be described based on drawings.

### First Embodiment

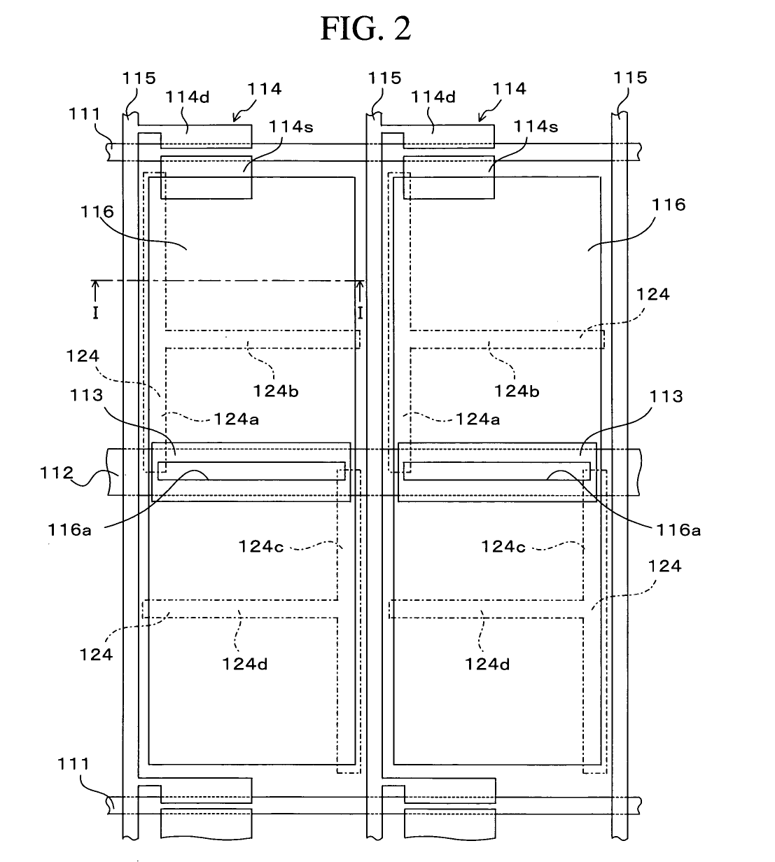

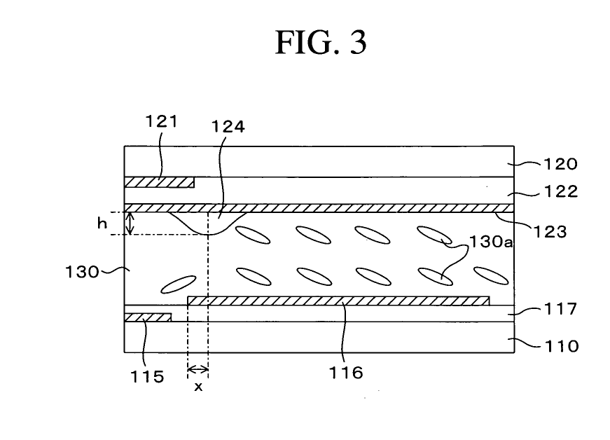

FIG. 2 is a plan view showing a liquid crystal display device of a first embodiment of the present invention. In this FIG. 2, two picture elements provided on a TFT substrate are shown. Further, in FIG. 3, a schematic cross section taken along the I-I line of FIG. 2 is shown. Note that numeric values in the following description are examples in the case of an XGA (1024×768 pixels) liquid crystal display device in which the panel size is 15 inches and in which the cell gap is 3.8 to 4.4 μm.

On the TFT substrate 110, a plurality of horizontally extending gate bus lines 111 and a plurality of vertically extending data bus lines 115 are formed. Each of the rectangular areas defined by the gate and data bus lines 111 and 115 is a picture element area. Further, on the TFT substrate 110, auxiliary capacitance bus lines 112, which are placed parallel to the gate bus lines 111 and cross the centers of the picture element areas, are formed. A first insulating film (not shown) is formed between each data bus line 115 and each of the gate bus lines 111 and the auxiliary capacitance bus lines 112. The gate bus lines 111 and the auxiliary capacitance bus lines 112 are electrically isolated from the data bus lines 115 by the first insulating film.

For each picture element area, a TFT 114, a picture element electrode 116, and an auxiliary capacitance electrode 113 are formed. In the TFT 114, part of a gate bus line 111 is used as a gate electrode. Further, the drain electrode 114d of the TFT 114 is connected to a data bus line 115, and the source electrode 114s thereof is formed at a position where the source electrode 114s faces the drain electrode 114d across the gate bus line 111. Furthermore, the auxiliary capacitance electrode 113 is formed at a position where it faces an auxiliary capacitance bus line 112 with the first insulating film interposed therebetween.

The auxiliary capacitance electrodes 113, the TFTs 114, and the data bus lines 115 are covered with a second insulating film 117. The picture element electrodes 116 are placed on the second insulating film 117. The picture element electrodes 116 are made of transparent conductive material, such as ITO, and electrically connected to the source electrodes 114s of the TFTs 114 and the auxiliary capacitance electrodes 113 through contact holes (not shown) formed in the second insulating film 117. Further, in the middle portion of each picture element electrode 116, a slit 116a is provided parallel to the gate bus lines 111. In the present embodiment, the width of the slit 116a is set to 5 μm or less (e.g., 4 μm). The surfaces of the picture element electrodes 116 are covered with a vertical alignment film (not shown) made of, for example, polyimide.

On a counter substrate 120, which is placed to face the TFT substrate 110, a black matrix 121, color filters 122, and a common electrode 123 are formed. The black matrix 121 is made of light blocking material, such as Cr (chromium), and placed above the gate bus lines 111, the auxiliary capacitance bus lines 112, the data bus lines 115, and the TFTs 114. Moreover, there are three types of color filters 122: red (R), green (G), and blue (B). A color filter of any one color is placed for each picture element. In the liquid crystal display device of the present embodiment, three picture elements of red, green, and blue which are placed in a horizontal line constitute one pixel. The common electrode 123 is made of transparent conductive material, such as ITO, and common to all picture element electrodes 116 on the TFT substrate 110.

As shown in FIG. 2, embankment-like protrusions 124 for domain regulation are formed in a predetermined pattern on the common electrode 123. Each protrusion 124 includes a portion (hereinafter referred to as a protrusion 124a) formed along the upper half of the left edge of a picture element electrode 116, a portion (hereinafter referred to as a protrusion 124b) horizontally extending from the middle of the protrusion 124a, a portion (hereinafter referred to as a protrusion 124c) formed along the lower half of the right edge of the picture element electrode 116, and a portion (hereinafter referred to as a protrusion 124d) horizontally extending from the middle of the protrusion 124c.

As shown in the schematic cross-sectional view of FIG. 3, the tops of the protrusions 124a and 124c are located inside the edges of the picture element electrode 116. In the present embodiment, the heights h of the protrusions 124a to 124d are set to 0.7 μm, and the horizontal distance x between each of the tops of the protrusions 124a and 124c and the corresponding edge of the picture element electrode 116 is set to 2.5 μm. The surfaces of the common electrode 123 and the protrusions 124a to 124d are covered with a vertical alignment film (not shown) made of, for example, polyimide.

Into the space between the TFT substrate 110 and the counter substrate 120, vertical alignment-type liquid crystals (liquid crystals with negative dielectric anisotropy) to which a component (reactive monomers) that is polymerized by ultraviolet light has been added are filled and sealed. The polymerization component added to the liquid crystals 130 is polymerized in a step to be described later to form polymers storing the alignment directions of the liquid crystal molecules 130a.

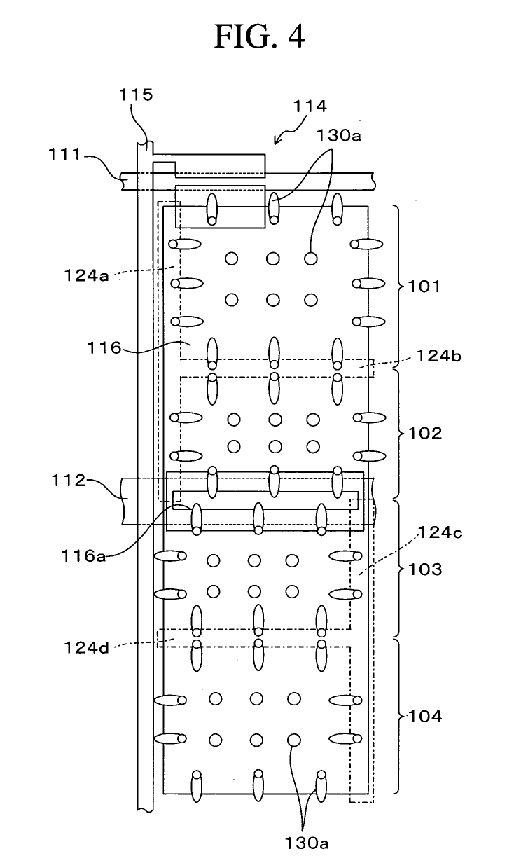

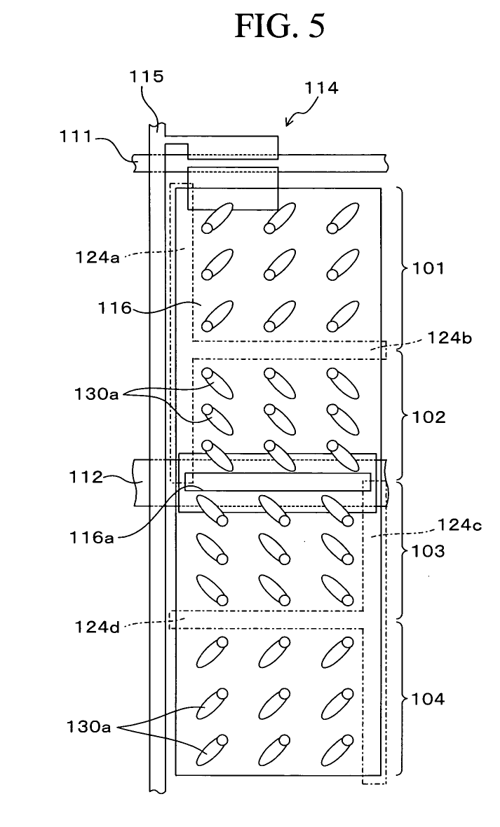

Next, the alignment state of the liquid crystal molecules in the liquid crystal display device constructed as described above will be described with reference to FIGS. 4 and 5. Here, in order to simplify explanation, four areas within each picture element, which are divided by the protrusions 124a to 124d and the slit 116a, are referred to as a first area 101, a second area 102, a third area 103, and a fourth area 104, beginning at the top, as shown in FIGS. 4 and 5.

FIG. 4 shows the alignment state of the liquid crystal molecules 130a immediately after a voltage has been applied between the picture element electrode 116 and the common electrode 123. First, the alignment of the liquid crystal molecules 130a in the first area 101 will be described.

The liquid crystal molecules 130a in the vicinities of the protrusions 124a and 124b are initially aligned with directions perpendicular to inclined surfaces of the protrusions 124a and 124b. Accordingly, due to the application of the voltage, a force which tends to tilt liquid crystal molecules in a direction (leftward) parallel to the gate bus line 111 acts on the liquid crystal molecules 130a in the vicinity of the protrusion 124a, and a force which tends to tilt liquid crystal molecules in a direction (downward) parallel to the data bus line 115 acts on the liquid crystal molecules 130a in the vicinity of the protrusion 124b.

Moreover, in edge portions of the picture element electrode 116, oblique electric flux lines occur toward the outside of the first area 101. Accordingly, a force which tends to tilt liquid crystal molecules in a direction (downward) parallel to the data bus line 115 acts on the liquid crystal molecules 130a in the vicinity of the edge parallel to the gate bus line 111, and a force which tends to tilt liquid crystal molecules in a direction (leftward) parallel to the gate bus line 111 acts on the liquid crystal molecules 130a in the vicinity of the edge parallel to the data bus line 115.

As described above, immediately after the voltage is applied, forces which tends to tilt liquid crystal molecules in predetermined directions act on the liquid crystal molecules 130a in the vicinities of the protrusions 124a and 124b and the vicinities of the edges of the electrode 116. However, the directions in which the liquid crystal molecules 130a in the central portion of the first area 101 are tilted are irregular.

In the four corners of the first area 101, a force which tends to tilt liquid crystal molecules in a direction (leftward) parallel to the gate bus line 111 and a force which tilts liquid crystal molecules in a direction (downward) parallel to the data bus line 115 act on the liquid crystal molecules 130a. As a result, the liquid crystal molecules 130a are tilted in a direction (lower left direction) of approximately 45° relative to the gate bus line 111. This tilt angle of the liquid crystal molecules 130a is propagated to the other liquid crystal molecules 130a within the first area 101. Consequently, as shown in FIG. 5, the liquid crystal molecules 130a in the entire first area 101 are tilted in the same direction (left and downward direction).

On the other hand, in the second area 102, the liquid crystal molecules 130a are initially aligned with a direction perpendicular to the inclined surfaces of the protrusions 124a and 124b. However, the first and second areas 101 and 102 have opposite initial alignment directions of the liquid crystal molecules 130a in the vicinity of the protrusion 124b.

When the voltage is applied, a force which tends to tilt liquid crystal molecules in a direction (leftward) parallel to the gate bus line 111 acts on the liquid crystal molecules 130a in the vicinity of the protrusion 124a, and a force which tends to tilt liquid crystal molecules in a direction (upward) parallel to the data bus line 115 acts on the liquid crystal molecules 130a in the vicinity of the protrusion 124b.

Moreover, in an edge portion of the picture element electrode 116 and an edge portion of the slit 116a, when the voltage is applied between the picture element electrode 116 and the common electrode 123, oblique electric flux lines occur toward the outside of the second area 102. Accordingly, a force which tends to tilt liquid crystal molecules in a direction (upward) parallel to the data bus line 115 acts on the liquid crystal molecules 130a in the vicinity of the edge of the slit 116a, and a force which tends to tilt liquid crystal molecules in a direction (leftward) parallel to the gate bus line 111 acts on the liquid crystal molecules 130a in the vicinity of the edge parallel to the data bus line 115. Further, the liquid crystal molecules 130a in the four corners of the second area 102 are tilted in the direction (upper left direction) of 45° relative to the gate bus line 111. This tilt angle of the liquid crystal molecules 130a is propagated to the other liquid crystal molecules 130a within the second area 102. Consequently, as shown in FIG. 5, the liquid crystal molecules 130a in the entire second area 102 are tilted in the same direction (upper left direction).

Similarly to the above, when sufficient time has elapsed after the voltage has been applied between the picture element electrode 116 and the common electrode 123, the liquid crystal molecules 130a in the third area 103 are tilted in a lower right direction and the liquid crystal molecules 130a in the fourth area 104 are tilted in an upper right direction as shown in FIG. 5.

After the tilt directions of the liquid crystal molecules 130a in the first to fourth areas 101 to 104 have been thus determined, the polymerization component added to the liquid crystals 130 is polymerized by irradiating ultraviolet light thereto, thereby forming polymers storing the tilt directions of the liquid crystal molecules 130a.

In the present embodiment, the four areas (domains) 101 to 104 having different alignment directions of liquid crystal molecules are formed in each picture element. Accordingly, the leakage of light in oblique directions relative to the normal to the liquid crystal panel is suppressed, and favorable viewing angle characteristics can be obtained. Further, in the present embodiment, the shapes of the protrusions and the slits for realizing alignment division are simple, and the loss of light in the domain boundary regions is small. Accordingly, a strong backlight is not required. This makes it possible to apply the present embodiment to a display of a notebook PC, which requires low power consumption.

Moreover, in the present embodiment, the polymerization component added to the liquid crystals is polymerized to form polymers, and the tilt directions of the liquid crystal molecules are stored in these polymers. Accordingly, all liquid crystal molecules within a picture element start being tilted in predetermined directions simultaneously with the application of a voltage. As a result, a favorable response speed can be obtained.

Furthermore, in the present embodiment, only one slit is formed in each picture element electrode, and the slit part is shielded with the auxiliary capacitance bus line 112 and the black matrix 121. Accordingly, the occurrence of a tiled pattern due to a photolithography process for forming the slits is prevented.

Hereinafter, a method of manufacturing the liquid crystal display device of the present embodiment will be described. To begin with, a method of forming the TFT substrate 110 will be described.

First, a glass substrate to be the TFT substrate 110 is prepared. Then, a first metal film is formed on the glass plate by physical vapor deposition (PVD), and the first metal film is patterned by photolithography, thus forming the gate bus lines 111 and the auxiliary capacitance bus lines 112. As the first metal film, a film formed by superimposing Al (aluminum) and Ti (titanium) or a Cr film can be used. Alternatively, the following may be adopted: an insulating film of SiO₂, SiN, or the like is formed as an underlying film on the glass substrate, and the first metal film is formed on the insulating film.

Next, a first insulating film (gate insulating film) made of, for example, SiO₂, is formed on the entire upper surface of the glass substrate, and a first silicon film to be active layers of the TFTs 114 and a SiN film to be channel protection films are sequentially formed on the first insulating film. After that, the SiN film is patterned by photolithography, thus forming channel protection films for protecting the channels of the TFTs 114 in predetermined areas above the gate bus lines 111.

Next, a second silicon film which is to be an ohmic contact layer and which has been heavily doped with impurities is formed on the entire upper surface of the glass substrate and, subsequently, a Ti—Al—Ti film stack, for example, is formed as a second metal film on the second silicon film. Then, the second metal film, the second silicon film, and the first silicon film are patterned by photolithography, thus fixing the shape of the silicon film to be active layers of the TFTs 114 and forming the data bus lines 115, the auxiliary capacitance electrodes 113, and the source and drain electrodes 114s and 114d of the TFTs 114.

Subsequently, a second insulating film 117 is formed on the entire upper surface of the glass substrate. In predetermined positions in this second insulating film 117, contact holes reaching the auxiliary capacitance electrodes 113 and the source electrodes 114s of the TFTs 114 are formed, respectively. After that, a film made of transparent conductive material, such as ITO, is formed on the entire upper surface of the glass substrate. Then, the film of transparent conductive material is patterned by photolithography, thereby forming the picture element electrodes 116 which has the slits 116a and which are electrically connected to the auxiliary capacitance electrodes 113 and the source electrodes 114s of the TFTs 114 through the contact holes. Thereafter, the picture element electrodes 116 are covered with a vertical alignment film made of polyimide. Thus, the TFT substrate 110 is completed.

Hereinafter, a method of manufacturing the counter substrate 120 will be described. First, a glass substrate to be the counter substrate 120 is prepared. Then, a metal film of Cr or the like is formed on the glass substrate, and the metal film is patterned, thus forming the black matrix 121. After that, the color filters 122 are formed on the glass substrate. At this time, a color filter 122 of any one color out of red, green, and blue is placed in each picture element.

Next, the common electrode 123 is formed of transparent conductive material, such as ITO, on the color filters 122. Then, a photoresist film is formed on the common electrode 123, and exposed and developed, thus forming the protrusions 124 (124a to 124d). In this case, if the heights of the protrusions 124 are too low (e.g., 0.35 μm or less), the alignment regulation power of the protrusions 124 becomes weaker than that of the electric fields in the edge portions of the picture element electrodes, and liquid crystal molecules are tilted in directions opposite to predetermined directions to disturb the alignment when the voltage is applied. Meanwhile, if the heights of the protrusions 124 are too high (e.g., 1.4 μm or more), the alignment regulation power of the protrusions 124 is too strong, and it is hard for the liquid crystal molecules 130a to be aligned with the directions of 45° relative to the protrusions 124.

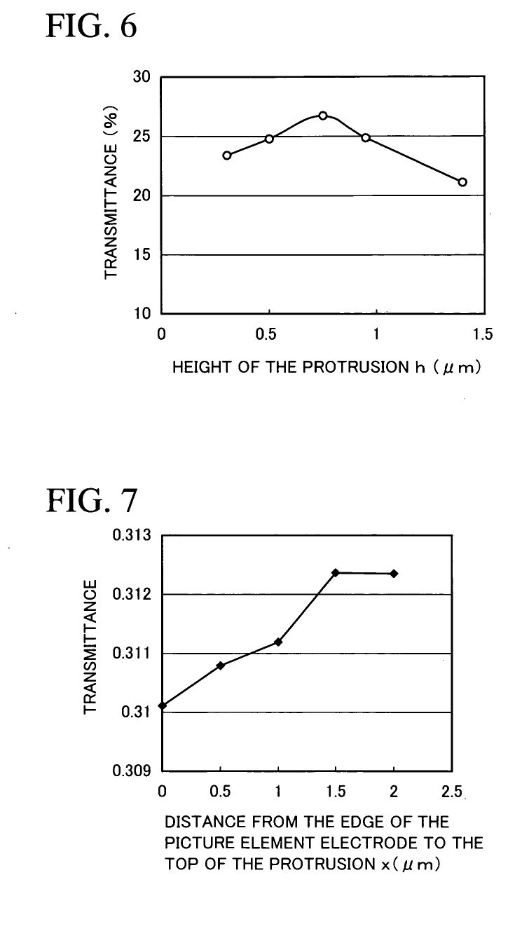

FIG. 6 is a graph showing the relationship between the height h (refer to FIG. 3) of the protrusion and the transmittance (%) by putting the height h on the horizontal axis and putting the transmittance (%) on the vertical axis. From this FIG. 6, it can be seen that the height h of the protrusion should be 0.5 to 1 μm in order to set the transmittance to approximately 25% and that the transmittance is highest when the height h of the protrusion is approximately 0.7 μm.

FIG. 7 is a graph showing the relationship between the distance x (refer to FIG. 3) from the edge of the picture element electrode to the top of the protrusion and the transmittance by putting the distance x on the horizontal axis and putting the transmittance on the vertical axis. It can be seen that the distance x from the edge of the picture element electrode to the top of the protrusion should be 1 μm or more in order to set the transmittance to 0.311 or more and that the transmittance is approximately constant when the distance x is 1.5 μm or more. In consideration of alignment errors during exposure and alignment errors when the TFT and counter substrates are adhered to each other, it is preferable to set the distance x from the edge of the picture element electrode to the top of the protrusion to 2 μm or more.

Next, liquid crystals 130 which has negative dielectric anisotropy and to which, for example, diacrylate monomers have been added as a polymerization component at 0.3 wt % are filled and sealed in the space between the TFT and counter substrates 110 and 120 by vacuum injection or drop injection. At this time, spacers having diameters of, for example, 4 μm are placed between the TFT and counter substrates 110 and 120, thus keeping constant the distance (cell gap) between the TFT and counter substrates 110 and 120.

Then, after the liquid crystal molecules have been aligned with predetermined directions by applying the voltage between the picture element electrodes 116 and the common electrode 123, the polymerization component in the liquid crystals is polymerized by applying ultraviolet light thereto. After that, polarizing plates are placed in crossed Nicols on both sides of the liquid crystal panel, and a driving circuit and a backlight unit are connected to the liquid crystal panel. Thus, the liquid crystal display device of the present embodiment is completed.

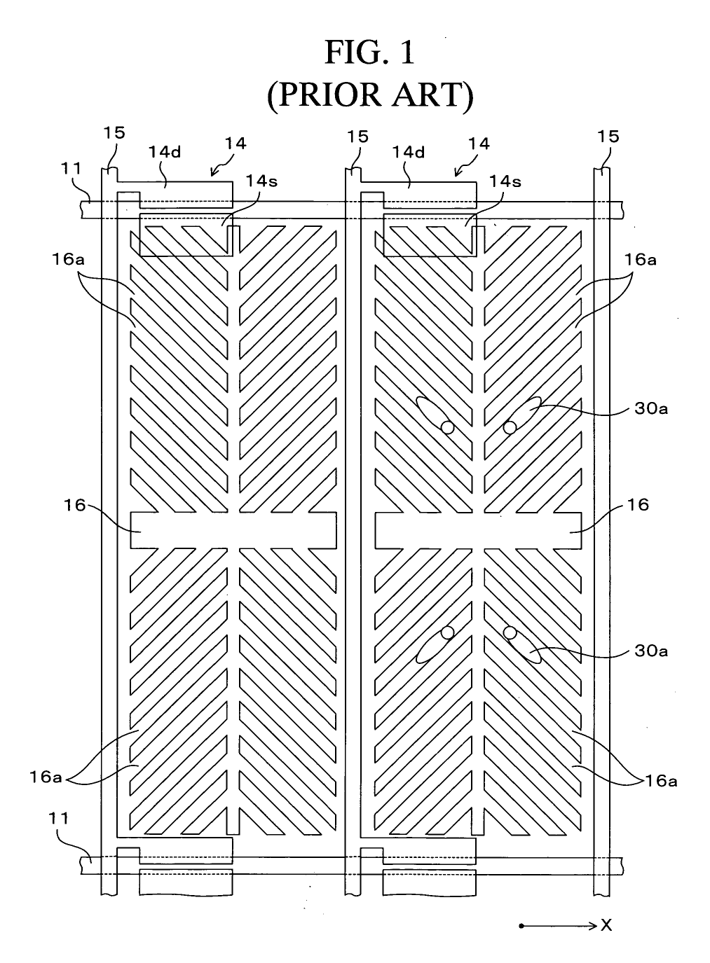

As a prior art example, a liquid crystal display device which has picture element electrodes having the shapes shown in FIG. 1 was manufactured, and characteristics thereof were investigated. Liquid crystals which has negative dielectric anisotropy and to which diacrylate monomers were added at 0.3 wt % were filled and sealed in the space between TFT and counter substrates. While a voltage was being applied between the picture element electrodes and a common electrode, polymers were formed in a liquid crystal layer by applying ultraviolet light to the liquid crystals, thus defining the alignment directions of liquid crystal molecules.

In the investigation of characteristics of this prior art liquid crystal display device, rather good values of the contrast of 700, the rise response speed of 15 ms, and the fall response speed of 10 ms were obtained. However, in the prior art liquid crystal display device, a tiled pattern was visibble.

On the other hand, when the liquid crystal display device according to the first embodiment was actually manufactured and characteristics thereof were investigated, the transmittance dropped by approximately 12% compared to the known example. However, unlike the prior art liquid crystal display device, a tiled pattern was not recognizeable.

### Second Embodiment

Hereinafter, a second embodiment will be described.

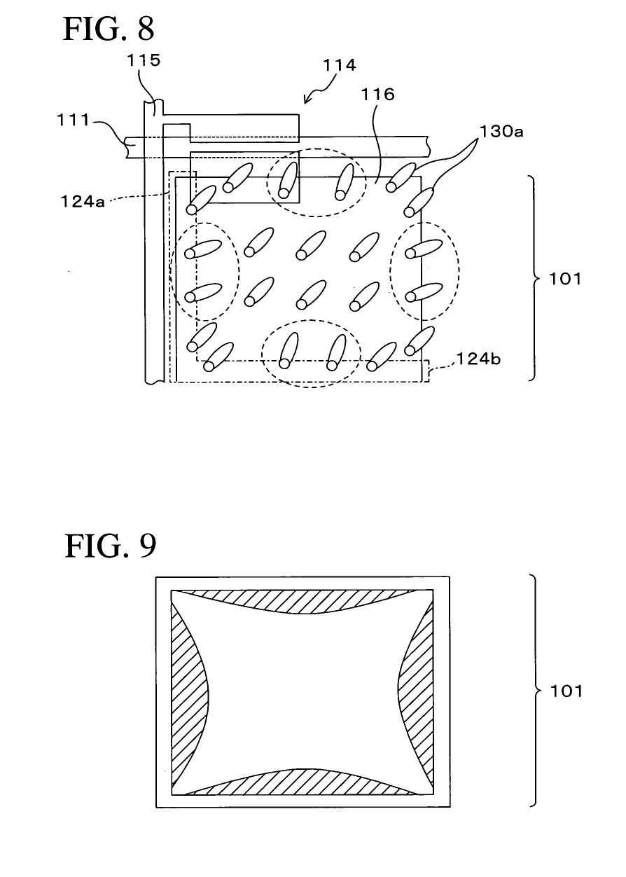

In the first embodiment, it is considered that, as shown in FIG. 8, for example, in the first area 101, the liquid crystal molecules 130a in the middle portions of the protrusions 124a, 124b, and the like and the middle portions of the edges of the picture element electrodes 116 (regions surrounded by broken lines in the drawing) are tilted in directions shifted from 45°, because the force which tends to tilt the liquid crystal molecules 130a downward and the force which tends to tilt the liquid crystal molecules 130a leftward are not equivalent. In the case where the liquid crystal molecules 130a are aligned as in this FIG. 8, a region with low transmittance occurs in the middle portion of each side of the first area 101 as shown in FIG. 9. This tendency becomes more prominent as the lengths of the sides of the first area 101 become longer.

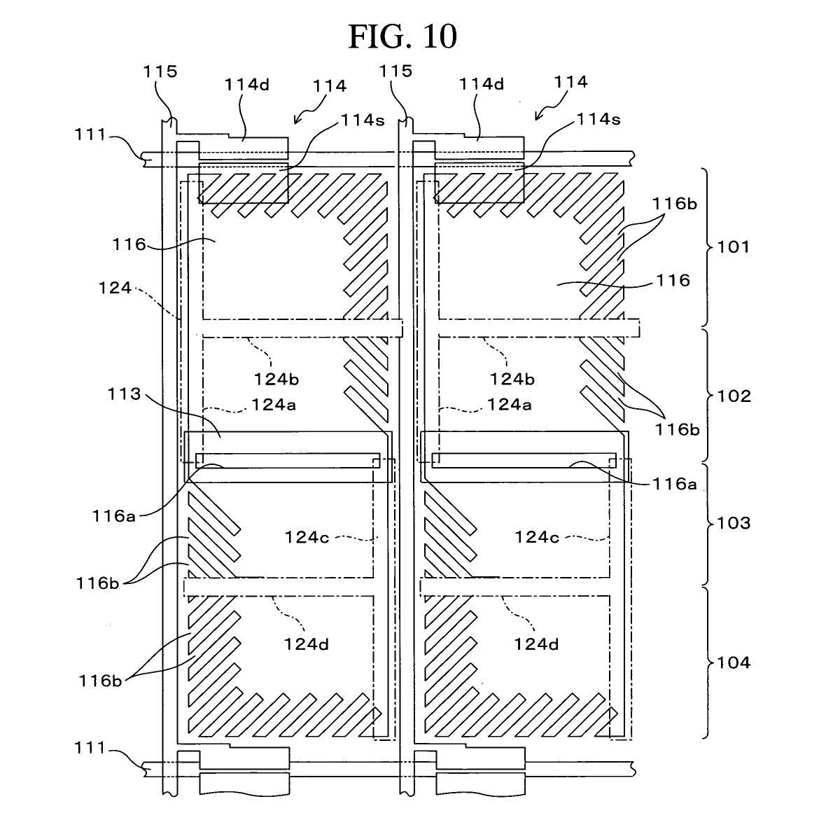

Accordingly, in the second embodiment, as shown in FIG. 10, slits (oblique slits) 116b for defining the alignment directions of liquid crystal molecules are formed in the edge portions of the picture element electrodes 116 on the opposite sides to the protrusions 124. These oblique slits 116b are formed in such a manner that the directions thereof match the alignment directions of the liquid crystal molecules in the first to fourth areas 101 to 104, that is, in such a manner that the directions thereof make an angle of 45° relative to the gate bus lines 111. Incidentally, the present embodiment differs from the first embodiment in that the oblique slits 116b are provided in the picture element electrodes 116 as described above. Except for this, the configuration is basically the same as that of the first embodiment. Accordingly, in FIG. 10, the same components as those in FIG. 2 are denoted by the same reference numerals and will not be further described in detail.

Forming the oblique slits 116b in the picture element electrodes 116 as described above reduces disorderly alignment directions of the liquid crystal molecules in the respective areas 101 to 104 and improves the transmittance.

The above-described liquid crystal display device of the second embodiment was actually manufactured, and characteristics thereof were investigated. Note that the widths, lengths, and pitch of the oblique slits 116b were set to 3 μm, 7 μm, and 7 μm, respectively. As a result, the transmittance of the liquid crystal display device of the present embodiment improved by approximately 15% compared to that of the liquid crystal display device of the first embodiment.

Incidentally, if the lengths of the oblique slits 116b are too long, it is considered that the variation in the slit widths possibly occurs due to a slight change of exposure conditions in a photolithography process to cause a tiled pattern as in the prior art. Accordingly, the regions where the oblique slits 116b are formed are preferably set within half the area of the picture element electrodes 116.

Further, if the widths of the oblique slits 116b are less than 2 μm, it is difficult to form the slits because the slit widths are too narrow. On the other hand, if the widths of the slits 116b are more than 5 μm, the effect of tilting liquid crystal molecules in predetermined directions becomes small. Accordingly, the widths of the slits 116b are preferably set to 2 to 5 μm. Moreover, also in the case where the lengths of the slits 116b are less than 3 μm, the effect of tilting liquid crystal molecules in predetermined directions becomes small. Accordingly, the lengths of the oblique slits 116b are preferably set to 3 μm or more.

### Third Embodiment

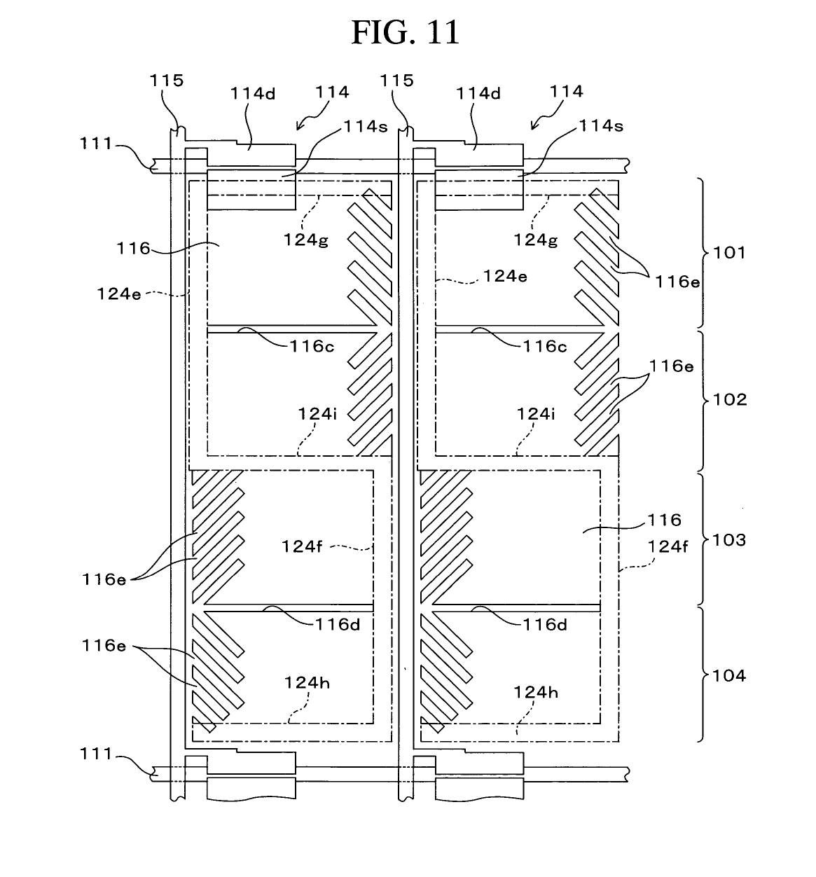

FIG. 11 is a plan view showing a liquid crystal display device of a third embodiment of the present invention. Incidentally, the third embodiment differs from the second embodiment in that the pattern of slits formed in picture element electrodes and the pattern of protrusions formed on a counter substrate differ from those of the second embodiment. Except for this, the configuration is basically the same as that of the second embodiment. Accordingly, in FIG. 11, the same components as those in FIG. 10 are denoted by the same reference numerals, and will not be further described in detail. Further, in FIG. 11, auxiliary capacitance bus lines and auxiliary capacitance electrodes are not shown.

In the present embodiment, a protrusion 124e is formed along the upper half of the left edge of each picture element electrode 116, and a protrusion 124f is formed along the lower half of the right edge of each picture element electrode 116. Further, a protrusion 124g is formed along the upper edge of each picture element electrode 116, a protrusion 124h is formed along the lower edge thereof, and a protrusion 124i is formed along each boundary between second and third areas 102 and 103 thereof.

Moreover, a slit 116c is formed along the boundary between first and second areas 101 and 102 of each picture element electrode 116, and a slit 116d is formed along the boundary between third and fourth areas 103 and 104 thereof. Furthermore, oblique slits 116e for regulating the alignment directions of liquid crystal molecules in the directions of 45° relative to gate bus lines 111 are formed in the edge portions of each picture element electrode 116 on the opposite sides to the protrusions 124e and 124f in the first to fourth areas 101 to 104.

In the present embodiment, oblique slits 116e are formed on only one side in each of the first to fourth areas 101 to 104, and the area of the oblique slits 116e in each of the first and fourth areas 101 and 104 is smaller than that of the liquid crystal display device of the second embodiment. Accordingly, in the present embodiment, in addition to the same effect of the second embodiment, it is possible to obtain the effect of more reliably preventing the occurrence of a tiled pattern due to a photolithography process.

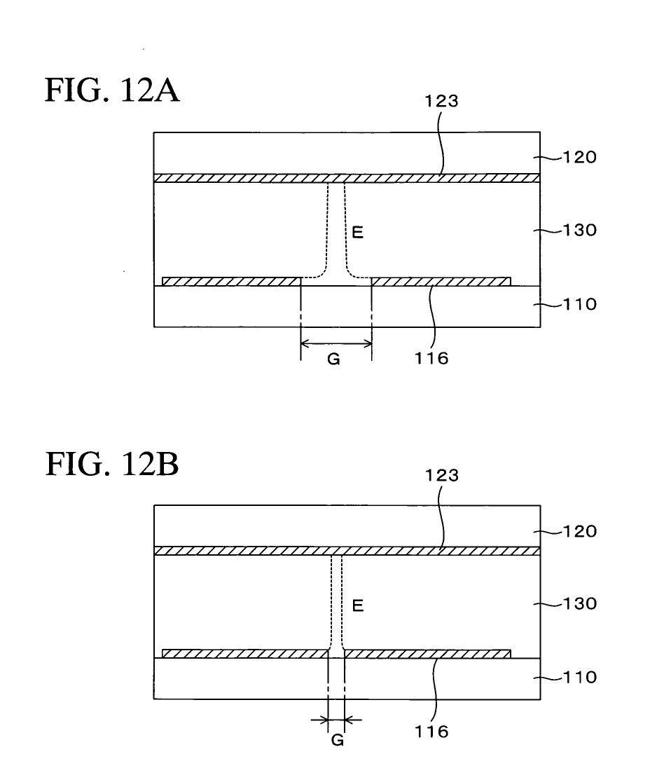

Incidentally, in the present embodiment, as shown in FIGS. 12A and 12B, as the slit widths G are narrowed, in the slit 116c between the first and second areas 101 and 102 and in the slit 116d between the third and fourth areas 103 and 104, the curvatures of electric flux lines E decrease, which causes forces that tilt liquid crystal molecules in directions perpendicular to the slits 116c and 116d to decrease. As a result, the liquid crystal molecules 130a become ultimately prone to tilt in the directions of 45° relative to the slits 116c and 116d, and dark regions as shown in FIG. 9 do not occur. In the present embodiment, the widths of the slits 116c and 116d are set to, for example, 4 μm.

### Fourth Embodiment

Hereinafter, a fourth embodiment will be described.

As described in the third embodiment, when the widths of slits are reduced, the curvatures of electric flux lines decrease, and forces which tilt liquid crystal molecules in directions perpendicular to the slits decrease. In the present embodiment, using this principle, disorderly alignment directions of liquid crystal molecules in the middle portions of the sides in first to fourth areas 101 to 104 is suppressed.

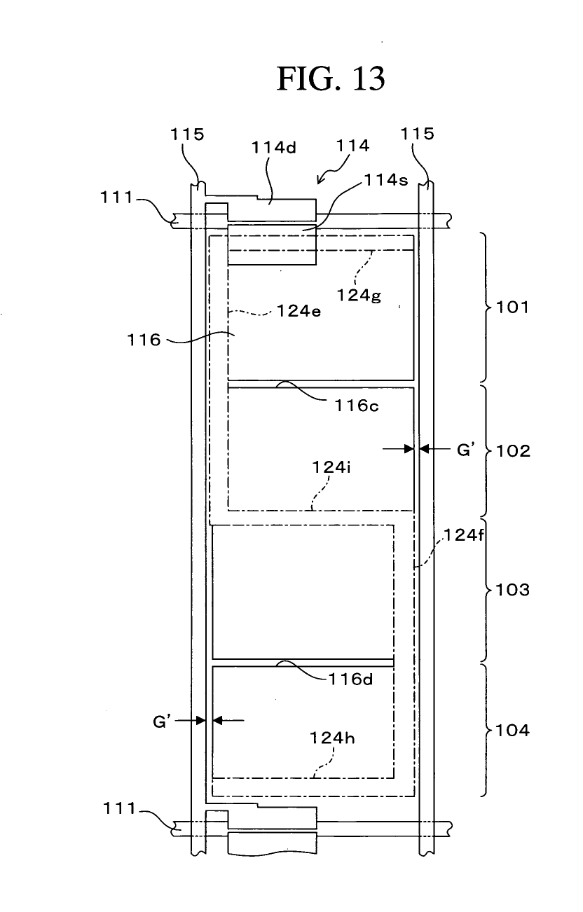

FIG. 13 is a plan view showing a liquid crystal display device of the fourth embodiment of the present invention. Note that, in FIG. 13, the same components as those in FIG. 11 are denoted by the same reference numerals and will not be further described in detail.

In the present embodiment, the distance G′ between the picture element electrode 116 and the data bus line 115 is set small. For example, the distance between the picture element electrode and the data bus line is 7 μm in a conventional MVA-mode XGA liquid crystal display device, whereas the distance G′ between the picture element electrode 116 and the data bus line 115 is set to 5 μm or less (4 μm in this example) in the liquid crystal display device of the fourth embodiment.

Further, when a polymerization component (e.g., diacrylate monomers) added to liquid crystals is polymerized by applying ultraviolet light thereto, a voltage almost the same as a voltage applied to the picture element electrodes 116 is applied to all data bus lines 115. Thus, the curvatures of the electric flux lines occurring from the edges of the picture element electrodes 116 on the data bus line 115 sides decrease due to the electric flux lines occurring from the data bus lines 115, and forces which cause liquid crystal molecules to be aligned with directions perpendicular to the data bus lines 115 are reduced. As a result, the liquid crystal molecules in first to fourth areas 101 to 104 are aligned with predetermined directions (directions of 45° relative to gate bus lines 111), respectively. The polymerization component in the liquid crystals is polymerized by irradiating ultraviolet light thereto in this state, whereby dark regions as shown in FIG. 9 do not occur.

According to the present embodiment, oblique slits do not need to be formed by photolithography. Accordingly, the present embodiment has the effect of more reliably preventing the occurrence of a tiled pattern compared to the third embodiment.

### Fifth Embodiment

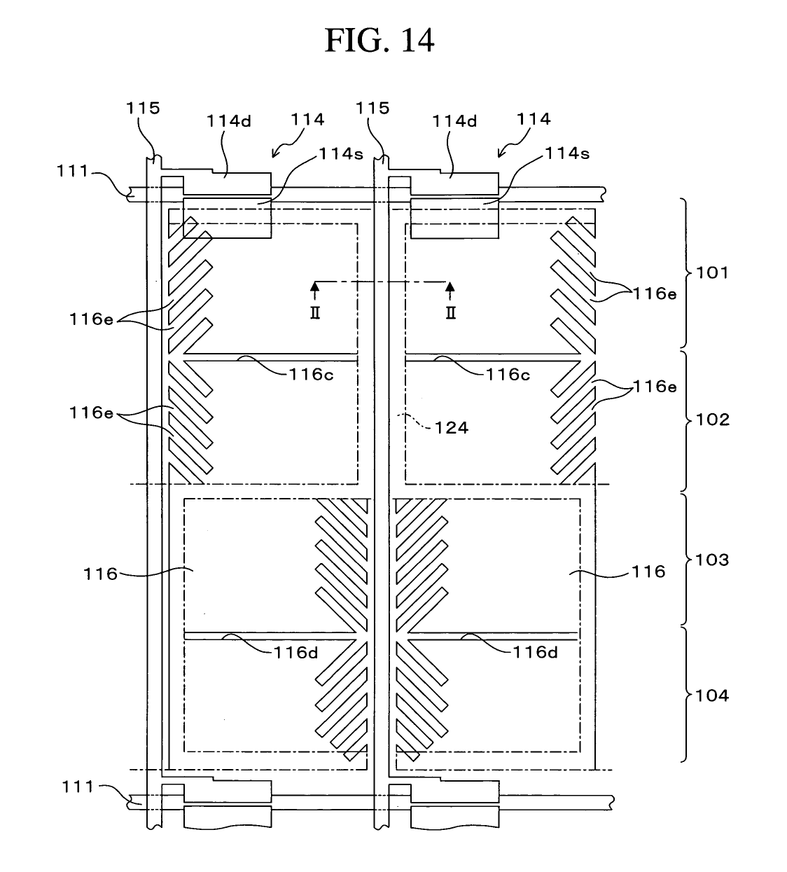

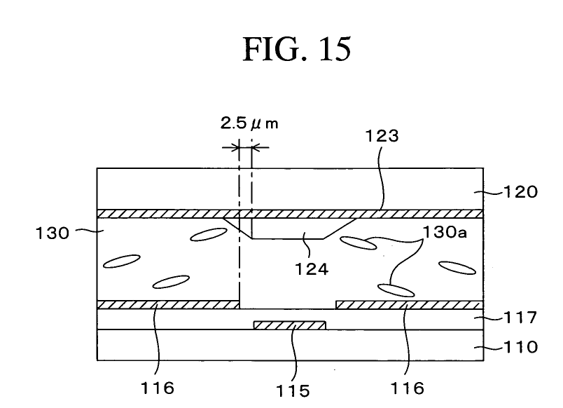

FIG. 14 is a plan view showing a liquid crystal display device of a fifth embodiment of the present invention, and FIG. 15 is a schematic cross-sectional view taken along the II-II line of FIG. 14. Incidentally, the present embodiment differs from the third embodiment in that the pattern shapes of slits provided in picture element electrodes on a TFT substrate and the pattern shapes of protrusions provided on a counter substrate differ from those of the third embodiment. Except for this, the basic configuration is the same as that of the third embodiment. Accordingly, in FIG. 14, the same components as those in FIG. 11 are denoted by the same reference numerals, and will not be further described in detail.

In the present embodiment, the patterns of the protrusions 124 and the patterns of oblique slits 116e in the picture element electrodes 116 of two horizontally adjacent picture elements are formed to be symmetric with respect to the data bus line 115 between the two picture elements. Moreover, in the present embodiment, as shown in FIG. 15, the inclined surfaces of the protrusions 124 formed above the data bus lines 115 are formed to protrude from the edges of the picture element electrodes 116 by 2.5 μm.

In the liquid crystal display device of the present embodiment, in addition to the same effect as that of the liquid crystal display device of the third embodiment, the following effect can be obtained. That is, in the liquid crystal display device shown in FIG. 11, it is considered that the protrusions 124 possibly enter the adjacent picture elements due to alignment errors when the TFT and counter substrates 110 and 120 are adhered to each other, and that liquid crystal molecules are therefore tilted in opposite directions.

On the other hand, in the present embodiment, the patterns of the protrusions 124 are symmetric with respect to the data bus lines 115. Accordingly, even if alignment errors occurs when the TFT and counter substrates 110 and 120 are adhered to each other, it is possible to avoid that the alignment directions of liquid crystal molecules 130a in each picture element become disordered.

### Sixth Embodiment

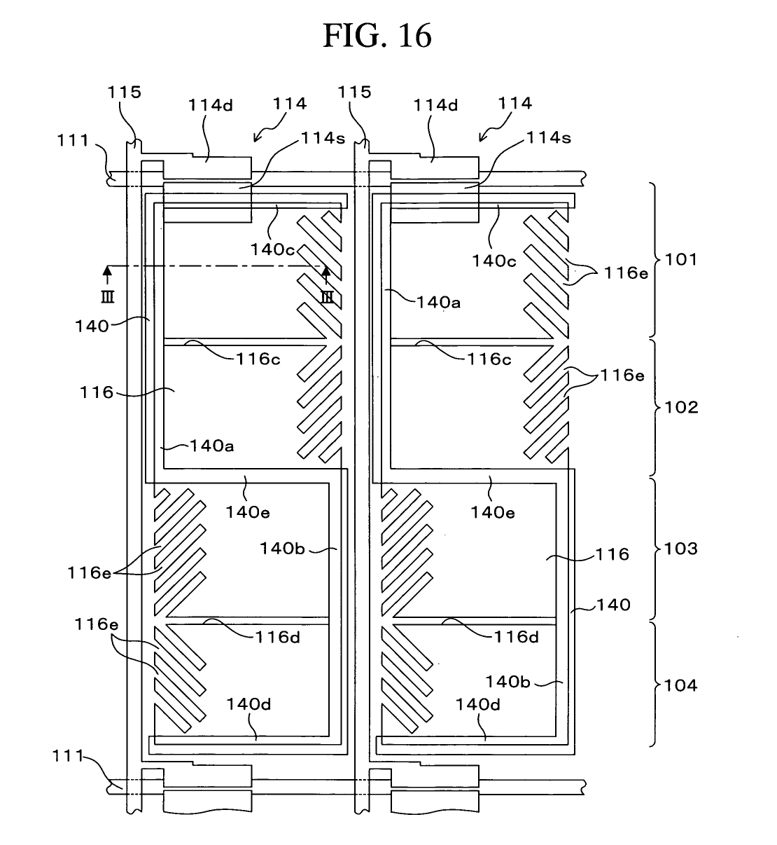

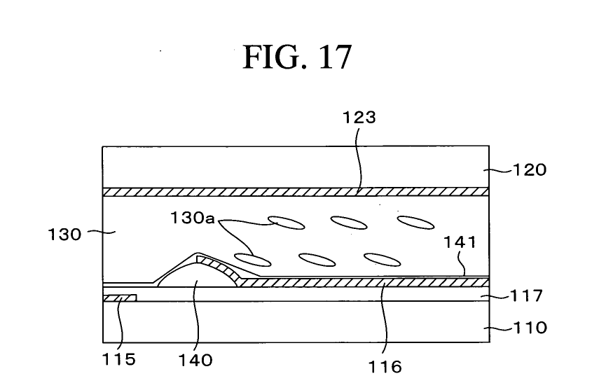

FIG. 16 is a plan view of a liquid crystal display device according to a sixth embodiment of the present invention, and FIG. 17 is a schematic cross-sectional view taken along the III-III line of FIG. 16. Incidentally, the present embodiment differs from the third embodiment in that protrusions are formed on a TFT substrate. Except for this, the configuration is basically the same as that of the third embodiment. Accordingly, in FIG. 16, the same components as those in FIG. 11 are denoted by the same reference numerals, and will not be further described in detail.

In the third embodiment, the protrusions are formed on the counter substrate 120. On the other hand, in the present embodiment, protrusions 140 having heights of, for example, 0.7 μm are formed on a TFT substrate 110. Each of these protrusions 140 includes a portion (hereinafter referred to as a protrusion 140a) formed along the upper half of the left edge of a picture element electrode 116, a portion (hereinafter referred to as a protrusion 140b) formed along the lower half of the right edge of the picture element electrode 116, a portion (hereinafter referred to as a protrusion 140c) formed along the upper edge of the picture element electrode 116, a portion (hereinafter referred to as a protrusion 140d) formed along the lower edge of the picture element electrode 116, and a portion (hereinafter referred to as a protrusion 140e) formed along the boundary between second and third areas 102 and 103.

The protrusions 140a to 140e are formed on a second insulating film 117 using, for example, photoresist. After the protrusions 140a to 140e have been formed, the picture element electrodes 116 are formed of transparent conductive material such as ITO. At this time, as shown in FIG. 17, the edge portions of the picture element electrodes 116 are placed on one inclined surfaces of protrusions 140 (protrusions 140a to 140d). Then, polyimide is applied to the entire surface, whereby a vertical alignment film 141 is formed.

Since the surface of the polyimide become uniform when the polyimide is applied, the angles (angles relative to the substrate plane) of the inclined surfaces of the alignment film 141 are smaller than the angles (angles relative to the substrate plane) of the edge portions of the picture element electrodes 116. Accordingly, the angles between the substrate plane and the electric flux lines penetrating the alignment film 141 are smaller than the angles between the substrate plane and the normals to the alignment film 141 in the edge portions of the picture element electrodes 116. As a result, as shown in FIG. 17, liquid crystal molecules 130a are tilted toward the protrusions 140.

In the third embodiment, it is preferred that the protrusions on the counter substrate 120 are placed at positions shifted toward the centers of the picture elements in advance in consideration of alignment errors when the TFT and counter substrates 110 and 120 are adhered to each other. However, this reduces the aperture ratio. On the other hand, in the present embodiment, since the protrusions are formed on the TFT substrate 110, there is no need to consider the alignment errors between the TFT and counter substrates 110 and 120. Accordingly, in the present embodiment, in addition to the same effect as that of the third embodiment, it is possible to obtain the effect of further increasing the aperture ratio.

### Seventh Embodiment

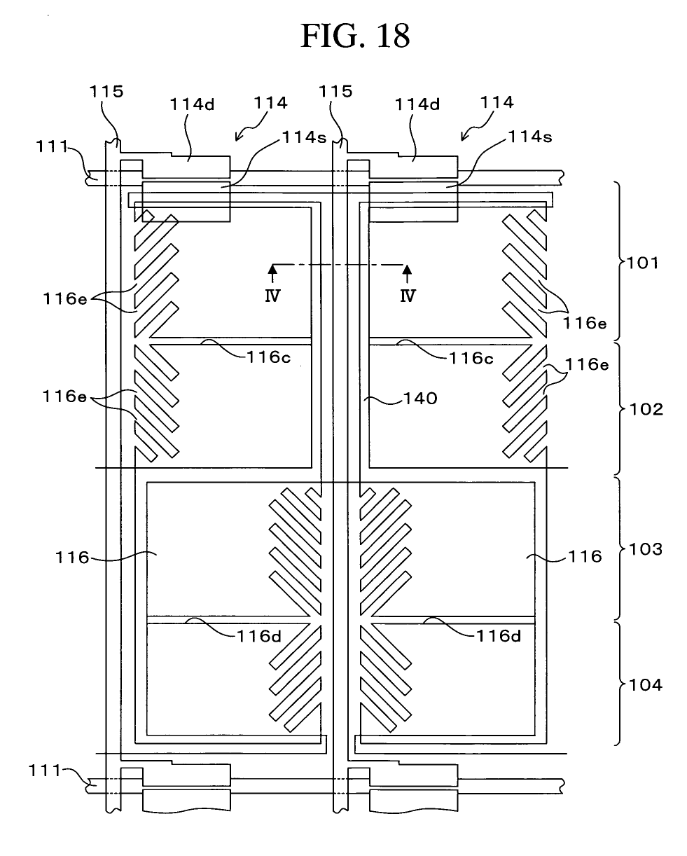

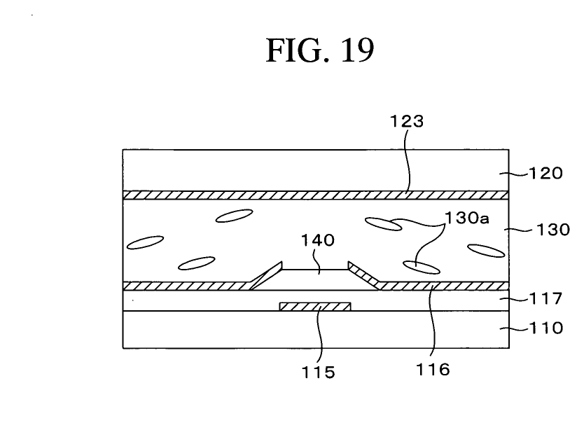

FIG. 18 is a plan view showing a liquid crystal display device of a seventh embodiment of the present invention, and FIG. 19 is a schematic cross-sectional view taken along the IV-IV line of FIG. 18. Incidentally, the present embodiment differs from the sixth embodiment in that the patterns of protrusions provided on a TFT substrate and the patterns of slits of picture element electrodes differ from those of the sixth embodiment. Except for this, the configuration is basically the same as that of the sixth embodiment. Accordingly, the same components are denoted by the same reference numerals, and will not be further described in detail.

In the present embodiment, the patterns of the protrusions 140 and the patterns of slits 116e in the picture element electrodes 116 of two horizontally adjacent picture elements are symmetric with respect to the data bus line 115 between the two picture elements. Moreover, in the present embodiment, as shown in FIG. 19, the inclined surfaces of the protrusions 140 are formed to the edge portions of the data bus lines 115.

In the liquid crystal display device of the present embodiment, the same effect as that of the sixth embodiment can be obtained.

### Eighth Embodiment

Hereinafter, an eighth embodiment of the present invention will be described.

In a liquid crystal display device having picture element electrodes as shown in FIG. 1, the occurrence of a tiled pattern is caused by the fact that the slit widths of the picture element electrodes change from a design value in a photolithography process to reduce the transmittance. Accordingly, if the transmittance is not greatly reduced even when the slit widths slightly change, the occurrence of a tiled pattern can be prevented. In the present embodiment, from such a viewpoint, the result of investigating the change in transmittance while changing the widths of slits and the spaces (hereinafter referred to as fine electrode widths) between the slits, will be described.

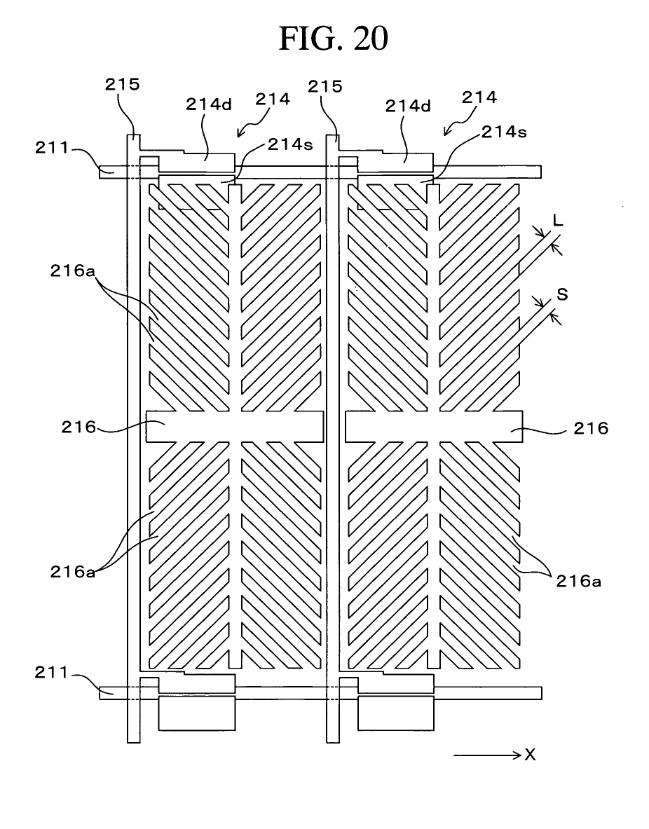

FIG. 20 is a plan view of a liquid crystal display device of the eighth embodiment. On the TFT substrate of the liquid crystal display device of the present embodiment, a plurality of gate bus lines 211 horizontally extending and a plurality of data bus lines 215 vertically extending are formed. Each of the rectangular areas defined by the gate and data bus lines 211 and 215 is a picture element area. The gate bus lines 211 are electrically isolated from the data bus lines 215 by a first insulating film formed therebetween.

For each picture element area, a TFT 214 and a picture element electrode 216 are formed. In the TFT 214, part of a gate bus line 211 is used as a gate electrode. Further, the drain electrode 214d of the TFT 214 is connected to a data bus line 215, and the source electrode 214s thereof is formed at a position where the source electrode 214s faces the drain electrode 214d across the gate bus line 211.

The TFTs 214 and the data bus lines 215 are covered with a second insulating film. On the second insulating film, the picture element electrodes 216 made of transparent conductive material, such as ITO, are formed. The picture element electrodes 216 are electrically connected to the source electrodes 214s of the TFTs 214 through contact holes formed in the second insulating film.

As shown in FIG. 20, in the picture element electrodes 216, a slit width is denoted by S (design value), and a fine electrode width is denoted by L (design value). Here, each picture element electrode 216 has a first area (upper right area) in which slits 216a are provided at the angle of 45° relative to the X-axis, a second area (upper left area) in which slits 216a at are provided the angle of 135° relative to the X-axis, a third area (lower left area) in which slits 216a are provided at the angle of 225° relative to the X-axis, and a fourth area (lower right area) in which slits 216a are provided at the angle of 315° relative to the X-axis. Moreover, the thickness (hereinafter referred to as a cell gap) of a liquid crystal layer between TFT and counter substrates is denoted by D (design value). Since the transmittance of the liquid crystal display device is a function of a voltage V, the transmittance for a voltage of V is represented as T(V). In the following description, the voltage V is assumed to be a voltage at which the transmittance T(V) becomes 5%.

On the other hand, assumptions are made that, after manufacture, the fine electrode width of the liquid crystal display device is reduced by 0.2 μm from the design value L, and the slit width thereof is increased by 0.2 μm from the design value S. Further, the cell gap of the liquid crystal display device after manufacture is assumed to be the same size as designed. The transmittance of this liquid crystal display device for a voltage of V is represented as T′(V). The observable degree of a tiled pattern in this liquid crystal display device can be evaluated by using the transmittance ratio T′(V)/T(V). It can be said that a tiled pattern is less likely to occur as the value of T′(V)/T(V) approaches 1, and is likely to occur as the value of T′(V)/T(V) decreases.

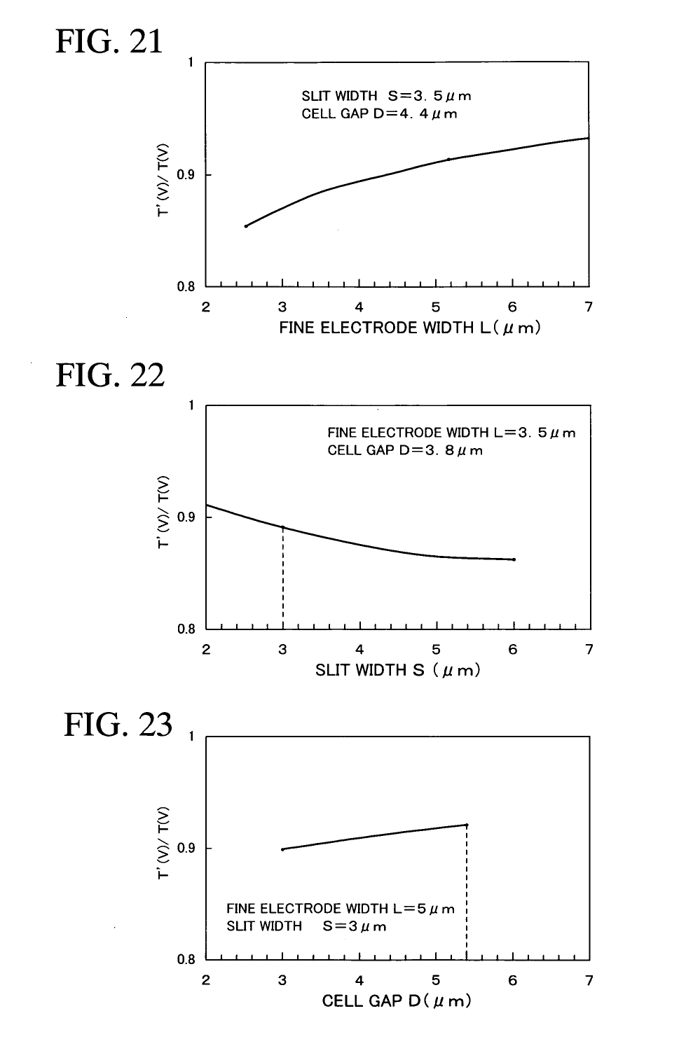

FIG. 21 is a graph showing the relationship between the fine electrode width L (design value) and the value of the transmittance ratio T′(V)/T(V) by putting the fine electrode width L on the horizontal axis and putting the value of the transmittance ratio T′(V)/T(V) on the vertical axis. Here, the slit width S (design value) is 3.5 μm, and the cell gap D (design value) is 4.4 μm. Further, the transmittance ratio T′(V)/T(V) is determined by simulation calculation on the assumption that the fine electrode width of the liquid crystal display device after manufacture is 0.2 μm smaller than the design value L and that the slit width thereof is 0.2 μm larger than the design value S as described previously.

From this FIG. 21, it can be seen that the transmittance ratio T′(V)/T(V) increases as the fine electrode width L increases. That is, a tiled pattern is likely to become less visible as the fine electrode width L increases. In addition, as can be seen from FIG. 21, the relationship between the fine electrode width L and the transmittance ratio T′(V)/T(V) is approximately linear. Such a relationship is the same even if the slit width S and the cell gap D are changed. The line representing the relationship between the fine electrode width L and T′(V)/T(V) is regarded as an ascending straight line.

FIG. 22 is a graph showing the relationship between the slit width S (design value) and the transmittance ratio T′(V)/T(V) by putting the slit width S on the horizontal axis and putting the transmittance ratio T′(V)/T(V) on the vertical axis. Here, the fine electrode width L (design value) is 3.5 μm, and the cell gap D (design value) is 3.8 μm. Further, as described previously, the transmittance ratio T′(V)/T(V) is determined by simulation calculation on the assumption that the fine electrode width of the liquid crystal display device after manufacture is 0.2 μm smaller than the design value L and that the slit width thereof is 0.2 μm larger than the design value S.

From this FIG. 22, it can be seen that the transmittance ratio T′(V)/T(V) decreases as the slit width S increases. That is, a tiled pattern is likely to become visible as the slit width S increases. In addition, as can be seen from FIG. 22, the relationship between the slit width S and the transmittance ratio T′(V)/T(V) is approximately linear. Such a relationship is the same even if the fine electrode width L and the cell gap D are changed. The line representing the relationship between the slit width S and T′(V)/T(V) is regarded as a descending straight line.

FIG. 23 is a graph showing the relationship between the cell gap D and the transmittance ratio T′(V)/T(V) by putting the cell gap D on the horizontal axis and putting the transmittance ratio T′(V)/T(V) on the vertical axis. Here, the fine electrode width L (design value) is 5 μm, and the slit width S (design value) is 3 μm. Further, as described previously, the transmittance ratio T′(V)/T(V) is determined by simulation calculation on the assumption that the fine electrode width of the liquid crystal display device after manufacture is 0.2 μm smaller than the design value L and that the slit width thereof is 0.2 μm larger than the design value S.

From this FIG. 23, it can be seen that the transmittance ratio T′(V)/T(V) increases as the cell gap D increases. That is, a tiled pattern is likely to become less visible as the cell gap D increases. In addition, as can be seen from FIG. 23, the relationship between the cell gap D and the transmittance ratio T′(V)/T(V) is approximately linear. Such a relationship is the same even if the fine electrode width L and the slit width S are changed. The line representing the relationship between the cell gap D and T′(V)/T(V) is regarded as an ascending straight line.

From these things, the following is estimated. That is, T′(V)/T(V) increases as the fine electrode width L increases, but T′(V)/T(V) decreases as the slit width S increases. From FIGS. 21 and 22, it can be seen that the gradient of the line representing the relationship between the fine electrode width L and T′(V)/T(V) and the gradient of the line representing the relationship between the slit width S and T′(V)/T(V) differ in sign but are approximately equal in absolute value. From this, T′(V)/T(V) is estimated to be approximately constant when the cell gap D is assumed to be constant and the difference between the fine electrode width L and the slit width S is assumed to be constant.

Similar to this, T′(V)/T(V) increases as the cell gap D increases, but T′(V)/T(V) decreases as the slit width S increases. From FIGS. 22 and 23, it can be seen that the gradient of the line representing the relationship between the cell gap D and T′(V)/T(V) and the gradient of the line representing the relationship between the slit width S and T′(V)/T(V) differ in sign but are approximately equal in absolute value. From this, T′(V)/T(V) is estimated to be approximately constant if the fine electrode width L and the difference between the cell gap D and the slit width S are constant.

Moreover, T′(V)/T(V) increases as the fine electrode width L increases, but T′(V)/T(V) decreases as the cell gap D decreases. From FIGS. 21 and 23, it can be seen that the gradient of the line representing the relationship between the fine electrode width L and T′(V)/T(V) and the gradient of the line representing the relationship between the cell gap D and T′(V)/T(V) are approximately equal. From this, T′(V)/T(V) is estimated to be approximately constant if the slit width S and the sum of the fine electrode width L and the cell gap D are constant.

Summarizing these relationships, it is expected that T′(V)/T(V) will be constant if L+D−S is constant. However, it is preferred that the cell gap D, the fine electrode width L, and the slit width S satisfy the following conditions.

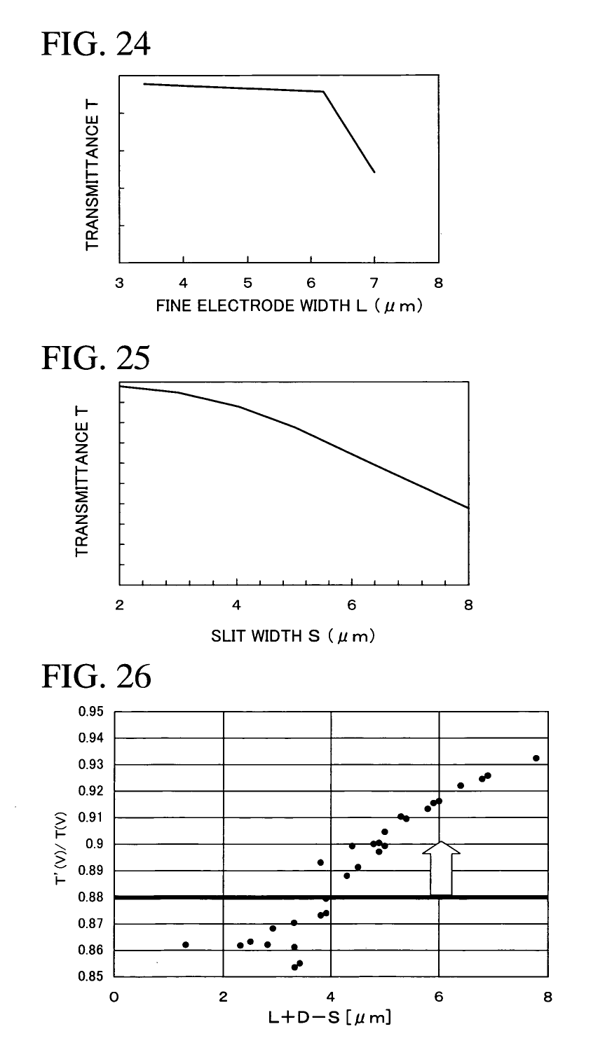

FIG. 24 is a graph showing the relationship between the fine electrode width L and the transmittance by putting the fine electrode width L on the horizontal axis and putting the transmittance on the vertical axis. As can be seen from this FIG. 24, when the fine electrode width exceeds 6 μm, the brightness sharply drops. When the fine electrode width exceeds 7 μm, the brightness decreases to approximately half its value for a value of the fine electrode width equal to 6 μm. This is because of the following fact: when the fine electrode width is 7 μm or less, liquid crystal molecules are tilted in directions parallel to the slits; however, when the fine electrode width is more than 7 μm, liquid crystal molecules are tilted in directions perpendicular to the slits, and disclination occurs in the fine electrodes. Accordingly, the fine electrode width L is preferably set to 7 μm or less, more preferably 6 μm or less.

FIG. 25 is a graph showing the relationship between the slit width and the brightness by putting the slit width on the horizontal axis and putting the brightness on the vertical axis. From this FIG. 25, it can be seen that the transmittance decreases as the slit width increases, and that the value of the brightness for a value of the slit width equal to 7 μm is approximately half that for a value of the slit width equal to 2 μm. Further, if the brightness for white is 0.9 or more, it can be seen that the slit width S is need to be set to 4 μm or less. Accordingly, the slit width S is preferably set to 7 μm or less, more preferably 4 μm or less.

Moreover, as a result of investigating the brightness while changing the cell gap, it turned out that the cell gap less than 2 μm was impractical because retardation becomes small due to limitations of liquid crystal material to reduce the brightness. Further, it turned out that the cell gap exceeding 6 μm was impractical, because retardation becomes too large due to limitations of liquid crystal material and light leaks in oblique directions at the time of black display to deteriorate viewing angle characteristics. Accordingly, the cell gap is preferably set to 2 to 6 μm.

Liquid crystal display devices having different fine electrode widths L, slit widths S, and cell gaps D were actually fabricated, and whether there would be a tiled pattern or not was investigated by visual inspection. Then, the relationship between the value of L+D−S and the transmittance ratio T′(V)/T(V) was investigated. The results are shown in FIG. 26.

118 The above-described experiment confirmed that a tiled pattern does not occur if the transmittance ratio T′(V)/T(V) is 0.88 or more as shown in FIG. 26. Further, it was confirmed that the transmittance ratio T′(V)/T(V) is 0.88 or more if the value of L+D−S is 4 μm or more (L+D−S≧4 μm).

Hereinafter, the result of fabricating four types of liquid crystal display devices (samples 1 to 4) having different values of L+D−S and investigating whether a tiled pattern occurs or not, will be described.

First, a TFT substrate having picture element electrodes of the shapes shown in FIG. 20 and a counter substrate having a common electrode were manufactured. Here, the fine electrode width L and the slit width S were set as shown in Table 1 below.

TABLE 1

| | L | S | D | L + D − S | EVALUATION |
|---|---|---|---|---|---|
| SAMPLE 1 | 3 | 3.5 | 3.8 | 3.3 | A TILED PATTERN IS |
| | | | | | CLEARLY VISIBLE |
| SAMPLE 2 | 3 | 3.5 | 4.4 | 3.9 | A TILED PATTERN IS |
| | | | | | SLIGHTLY VISIBLE |
| SAMPLE 3 | 3.5 | 3 | 3.8 | 4.3 | A TILED PATTERN IS |
| | | | | | NOT VISIBLE |
| SAMPLE 4 | 5 | 3.5 | 4.4 | 5.9 | NO TILED PATTERN IS |
| | | | | | VISIBLE AT ALL |

Next, the TFT and counter substrates were adhered to each other with spacers, which determine the cell gap, interposed therebetween. Liquid crystals with negative dielectric anisotropy were filled and sealed in the space between the TFT and counter substrates, thus forming a liquid crystal panel. As a polymerization component, diacrylate monomers were added to the liquid crystals at 0.3 wt %. Here, as shown in Table 1, the cell gap D was set to 3.8 μm for samples 1 and 3, and the cell gap D was set to 4.4 μm for samples 2 and 4.

122 Next, after liquid crystal molecules have been aligned with predetermined directions along slits by applying a voltage between the picture element electrodes and the common electrode, polymers storing the tilt directions of the liquid crystal molecules were formed in a liquid crystal layer by applying ultraviolet light thereto.

Subsequently, polarizing plates were placed in crossed Nicols on both sides of the liquid crystal panel. That is, one polarizing plate was placed in such a manner that the absorption axis thereof was parallel to gate bus lines, and the other polarizing plate was placed in such a manner that the absorption axis thereof was parallel to data bus lines.

The results of investigating the value of L+D−S and whether a tiled pattern occurs or not for the liquid crystal display devices of samples 1 to 4 thus manufactured are shown in Table 1 together. As can be seen in the Table 1, in the liquid crystal display devices of samples 1 and 2, in which the values of L+D−S are less than 4 μm, tiled patterns occurred. On the other hand, in the liquid crystal display devices of samples 3 and 4, in which the values of L+D−S are 4 μm or more, tiled patterns were not visible.

1. A liquid crystal display device comprising:
a first substrate on which a picture element electrode is formed for each picture element area;
a second substrate on which a common electrode placed to face the picture element electrode is formed; and
a liquid crystal layer consists of vertical alignment-type liquid crystals filled and sealed in a space between the first and second substrates,
wherein each picture element area is divided into a plurality of rectangular areas, two adjacent sides of each rectangular area are defined by embankment-like protrusions made of dielectric material, other two sides are defined by edges of the picture element electrode, and liquid crystal molecules are aligned with directions intersecting each side of the rectangular area when a voltage is applied between the picture element electrode and the common electrode.

2. The liquid crystal display device according to claim 1, wherein polymers storing alignment directions of the liquid crystal molecules are formed in the liquid crystal layer.

3. The liquid crystal display device according to claim 1, wherein at least one of the edges of the picture element electrode which define two sides of each rectangular area is an edge of a slit provided in the picture element electrode.

4. The liquid crystal display device according to claim 3, wherein a width of the slit is 5 μm or less.

5. The liquid crystal display device according to claim 1, wherein at least one of the protrusions which define two sides of each rectangular area is formed along an outer edge of the picture element electrode.

6. The liquid crystal display device according to claim 5, wherein a top of the protrusion is located inside the outer edge of the picture element electrode.

7. The liquid crystal display device according to claim 6, wherein a distance between the top of the protrusion and the outer edge of the picture element electrode is 1 μm or more.

8. The liquid crystal display device according to claim 1, wherein oblique slits extending in the alignment directions of the liquid crystal molecules when the voltage is applied are provided in edge-side portions which define sides of each rectangular area.

9. The liquid crystal display device according to claim 8, wherein widths of the oblique slits are 2 μm to 5 μm, and lengths thereof are 3 μm or more.

10. The liquid crystal display device according to claim 8, wherein an area of a region in which the oblique slits are formed is 50% or less of an area of the picture element electrode.

11. The liquid crystal display device according to claim 1, wherein heights of the protrusions are 1 μm or less.

12. The liquid crystal display device according to claim 1, further comprising:
a thin film transistor connected to the picture element electrode;
a gate bus line connected to the thin film transistor; and
a data bus line which is connected to the thin film transistor and extends in a direction perpendicular to the gate bus line.

13. The liquid crystal display device according to claim 12, wherein a distance between the picture element electrode and the data bus line is 5 μm or less.

14. The liquid crystal display device according to claim 1, wherein in two adjacent picture element areas, patterns of the protrusions are symmetric.

15. The liquid crystal display device according to claim 14, wherein part of the protrusions are formed to spread across the two picture elements.

16. The liquid crystal display device according to claim 15, wherein an edge of the picture element electrode is located 2 μm or more closer to a picture element center than a top-side end portion of an inclined surface of the protrusion formed to spread across the two picture elements.

17. The liquid crystal display device according to claim 1, wherein the protrusions are formed on the first substrate.

18. The liquid crystal display device according to claim 1, wherein the protrusions are formed on the second substrate.

19. A liquid crystal display device comprising:
a first substrate on which a picture element electrode is formed for each picture element area;
a second substrate on which a common electrode placed to face the picture element electrode is formed; and
a liquid crystal layer consists of vertical alignment-type liquid crystals filled and sealed in a space between the first and second substrates,
wherein the picture element electrode has stripe-shaped slits for defining alignment directions of liquid crystal molecules, and
L+D−S≧4 μm is satisfied, where a width of each slit is denoted by S, a distance between the slits is denoted by L, and a cell gap is denoted by D.

20. The liquid crystal display device according to claim 19, wherein polymers storing the alignment directions of the liquid crystal molecules are formed in the liquid crystal layer.

21. The liquid crystal display device according to claim 19, wherein the distance L between the slits is 7 μm or less.

22. The liquid crystal display device according to claim 19, wherein the width S of each slit is 7 μm or less.

23. The liquid crystal display device according to claim 19, wherein the cell gap D is 2 μm to 6 μm.

24. The liquid crystal display device according to claim 19, wherein the picture element electrode is divided into four areas having different directions of the slits, the directions of the slits being different from each other by 90°.
